(19) United States
(12) Patent Application Publication
(10) Pub. No.: US 2012/0003495 A1
(43) Pub. Date: Jan. 5, 2012

(54) PART MADE OF A COMPOSITE, INCLUDING LIGHTNING PROTECTION MEANS

(76) Inventors: Frederick Cavaliere, Montigny Le Bretonneux (FR); Daniel Aliaga, Aubervilliers (FR)

(21) Appl. No.: 13/139,648

(22) PCT Filed: Dec. 14, 2009
(86) PCT No.: PCT/EP09/67080

§ 371 Date: Sep. 21, 2011

(30) Foreign Application Priority Data
Dec. 15, 2008 (FR) 0858577

(51) Int. Cl. B32B 3/24; B29C 43/12; B32B 15/08; B32B 15/01

(52) U.S. Cl. 428/596; 428/138; 264/511

(57) ABSTRACT

The invention relates to a part (11) made of a composite formed from a thermosetting resin, which includes lightning protection element including, on an upper surface (12) of the part (11) liable to be exposed to lightning strikes, a continuous layer of a metal foil (1) having perforations (2) with a degree of perforation between 0.005% and 20%.

The present invention falls within the field of parts made of a composite, and more specifically of such parts including means of protection against the effects of lightning.

The invention relates more specifically to parts made of a composite formed from a resin of the thermosetting type.

The use of composites is nowadays widespread in many industrial fields such as, for example, automobile, aircraft and building construction, in particular because of the savings in mass that can be achieved with these materials compared to conventional materials with equivalent mechanical properties.

The composites that the present invention relates to are formed of fibers embedded in a polymer resin. These fibers are usually long, and they can be woven or not, mineral or organic, such as for example glass or carbon fibers. They are held by an organic polymeric resin matrix, which can be thermoplastic or thermosetting. For this latter type of resin, to which the invention applies more specifically, the cross-linkage is initiated by heat and is irreversible.

Parts made of a composite formed from a thermosetting resin are manufactured in a conventional way by utilizing a mold. Layers of fibers impregnated with non-hardened resin are deposited and stacked in plies in an open mold, the molding surface of which has the shape of the part to be produced, so as to form a composite laminate. These layers may be covered by environmental products, generally comprising a cloth for bleeding the excess of resin and a breather cloth, which may be separated by plastic films, then by a flexible bladder defining between it and the mold a volume that allows the plies to be pressurized, under the effect of atmospheric pressure, by producing a partial vacuum in said volume, so as to compact the various plies together. During the pressurization, the breather cloth positioned between the part and the bladder evacuates the air and the solvent vapors coming from the resin away from the composite laminate. The assembly then undergoes curing, for example in an autoclave, with the partial vacuum maintained, so as to achieve the polymerization of the resin and the cohesion of the plies, giving the part its rigidity and its advantageous mechanical characteristics. The solvent vapors vented during this curing continue to be evacuated via the breather cloth. The part is then demolded. Depending on the techniques used, for obtaining thin parts comprising at least one curvature, the mold can be male, i.e. with a mainly convex molding surface of the part, or female, with a mainly concave molding surface of the part.

The preferred field of application of the invention, although non-limiting, is the manufacture of aircraft structural parts, in particular panels or sections of fuselage. Such parts are usually thin and they have a curvature. They are particularly exposed during use, especially in flight, to lightning strikes. It is clear that it is essential for them to be protected against the harmful effects of these strikes. A problem linked to the use of composites is the fact that intrinsically they exhibit poor behavior in response to of lightning strikes. They are usually electrically insulating or have low conductivity, thus they are unable to evacuate the current associated with the lightning. This leads to a high risk of damage to the structure in line with the strike.

To remedy this major disadvantage, it is standard for the parts made of composites that form the fuselage panels to include, generally on their outer surface, an electrically conductive lightning protection layer, notably in the form of a metal grid. Such a feature has the effect of improving the part's conductivity. The lightning current is thus dispersed over the surface of the part along the wires of the grid, and the part's resistance to lightning is increased.

However, such a solution is not completely satisfactory, since the electrical conductivity of the part thus formed is not uniform because of the grid's anisotropy. Moreover, the parts thus formed are penalized by the necessary mass of grids made of bronze or copper alloy, which is generally between 80 and 300 g/m², and whose meshes are filled with resin, which makes the assembly heavier and is contrary to the continuous constraints of optimizing the mass of the constituent parts of aircrafts.

This invention aims to remedy the drawbacks of existing parts made of composites and including protection against the effects of lightning, in particular those described above, by proposing a part of this type that offers a high level of protection against the effects of lightning and which can, in addition, be manufactured, in a form directly including lightning protection means, by the molding techniques used conventionally to manufacture composite parts from a thermosetting resin, including those utilizing a mold known as a male mold. The invention also envisages that the part has the smallest mass possible, notably to satisfy the requirements for optimizing the mass of the elements used to form aircrafts.

For reasons of convenience, throughout this description the term ‘lightning protection’ will be used to refer to the protection against the effects of lightning, it being clearly understood that here it does not mean avoiding having lightning touch the part, but rather ensuring that the effects of the lightning strike on the part are handled as well as possible so as to ensure that they are not harmful for the part, and more generally for the vehicle in which it is included.

According to the invention, a part made of a composite formed from a thermosetting resin, which includes lightning protection means, is characterized in that the lightning protection means comprise, on an upper surface of the part liable to be exposed to lightning strikes, a continuous layer of a metal foil having perforations with a degree of perforation per unit area, expressing the surface area occupied by the perforations over the foil in relation to the total surface area of the foil, comprised between 0.005% and 20%.

In a completely advantageous way, the surface area of each of the perforations is also less than or equal to 20 mm².

‘Continuous layer of a metal foil’ here encompasses equally the case in which the layer is formed of a single foil, which occupies the complete surface of the part liable to be exposed to lightning strikes, and the case in which this layer is formed of a plurality of juxtaposed metal foils, preferably substantially identical to each other, which together form the entire layer. These foils thus cover each other at their respective edges, so as to ensure the continuity of the metallization layer over the entire targeted surface of the part. This latter case, utilizing a plurality of foils, is the most common in practice, particularly in the field of aircraft structural parts, because of the large dimensions of these parts.

Generally, the outer surface of the part liable to be exposed to lightning strikes corresponds substantially to the total outer surface of the part. For reasons of practical convenience in the industrial implementation, it is especially advantageous in all cases to provide for the whole of the upper surface of the part to be covered by the metallization layer.

In the context of the preferred field of application of the invention in which the part is a panel or a section of an aircraft fuselage, on the finished vehicle the part's upper surface is the surface exposed on the outside of the vehicle, and it is on this surface that lightning is likely to strike. The metallization layer, formed of electrically conductive metal foils, is advantageously positioned on this upper surface, thus the lightning current is dispersed over the surface of this layer as soon as it comes into contact with the part.

The use of metal foils according to the invention is particularly advantageous, firstly because it provides an effective evacuation of the currents from the lightning, in all directions of the plane of the continuous layer of foils, without anisotropy, and secondly because the foils have a reduced mass, notably much less than that of a grid, whose meshes are moreover generally filled with resin during the manufacture of the part by molding. This reduced mass satisfies the requirements in this regard for aircraft parts.

Further, the part according to the invention can advantageously be manufactured by a conventional molding method, by means of either a male mold or a female mold.

In many cases, for manufacturing parts made of a composite formed from a thermosetting resin, especially but not exclusively in the aeronautics field, the use of molds known as male molds, i.e. having a mainly convex molding surface, is preferred. This is the case in particular for manufacturing aircraft fuselage panels. In the context of the manufacture of such panels, the part's upper face, which is convex and which will subsequently be exposed to the risk of lightning strikes, is thus formed opposite to the also convex molding surface of the mold. The part's lower concave face is formed against the molding surface, which guarantees a better dimensional tolerance. This is especially advantageous in the context of fuselage panels, which are assembled by their lower face on a support frame of the aircraft, and for which it is therefore important to have good dimensional accuracy for the lower face.

According to a method of manufacturing a part made of a composite according to the invention, which utilizes a mold with a mainly convex molding surface, layers of fibers impregnated with thermosetting resin, conventional in themselves, are deposited over a mold so as to form a composite laminate.

A metal foil, or a plurality of juxtaposed metal foils, perforated according to the invention, are applied over the laminate so as to form a continuous layer over one of its faces. This continuous layer can be formed of a single unique foil. In the case in particular of large-sized parts, it can also be formed of a plurality of substantially identical foils overlaying each other at their respective edges, so as to ensure the continuity of the lightning protection over the entire upper surface of the part. Each of the metal foils is preferably covered by a layer of non-polymerized thermosetting resin on one face, and possibly on its two opposite faces, such that, for its inner face positioned against the composite laminate, it has better adhesion to the laminate, and/or, for its opposite outer face, positioned on the outside of the part, it is protected by the layer of resin thus formed during subsequent surface treatment operations, which are usually carried out before the part is painted. Impregnating resin on one of the metal foil's two faces, or even both, can also form protection for a surface treatment that may be carried out on the foil during its manufacture.

On the layer of metal foils are successively positioned, in a conventional way, cloths for bleeding the excess resin and for breathing the air and solvent vapors, then a flexible bladder sealed on its edges with the mold.

A partial vacuum is then realized between the bladder and the mold. The latter is subjected to temperature and pressure cycles so as to achieve the polymerization and hardening of the resin.

During these latter operations, the metal foil layer on the laminate evacuates the air and the solvent vapors that may come from the resin away from the laminate, despite the fact that the metal forming the foil is intrinsically hermetic to air and solvent vapors. This result is achieved by the metal foil's perforations, made according to parameters advantageously chosen according to the invention so as to obtain the best compromise between, on the one hand, the effectiveness of this evacuation of air and solvents when the part is manufactured and, on the other hand, the effectiveness of the lightning protection of the part produced. This effectiveness is ensured by the lightning current being rapidly dispersed over the entire surface of the part's metallization layer. The presence of perforations, according to the degree per unit area and to the range of surface values specified by the invention, does not alter the advantageous properties of the metal foils in terms of the material's good conductivity in the plane, good conductivity in all directions of the plane and good evacuation of electrical charges, the metal foil having the advantage of uniform characteristics in all directions of the foil's plane. It should be noted here that the continuous layer of metal foils according to the invention is intended to cover large surfaces of the aircraft structural parts, the effectiveness of the lightning protection being obtained by dispersing the current from the lightning in all directions, over a large surface of this metallization layer.

In addition, to a certain extent, during the curing step the perforations allow the excess resin included in the composite laminate and at the interface of the laminate and the metal layer, to flow towards the bleeding cloth.

The metal foil according to the invention can be used equally well in the context of a manufacturing method utilizing a mold with a female molding surface, i.e. in which the part's upper convex face is formed against the mold's mainly concave molding surface, while the lower face is formed opposite to it. In this case, the metal foil layer is positioned on the mold before the composite laminate layers. The following steps are then carried out in the same way as described above, to obtain a part according to the invention.

The degree of perforation of the metal foil, or of the metal foils forming the continuous metallization layer, is advantageously between 0.005% and 20%, preferably between 0.005% and 5%, and for preference between 0.005 and 0.5%, so as to approach as closely as possible the behavior of a continuous foil in terms of dispersing currents from lightning.

In preferred embodiments of the invention, the perforations are positioned according to a regular pattern, especially a grid, so as to ensure substantially equivalent conductivity of the current in all directions of the plane of the metallization layer, from the lightning's point of impact.

Still with the same objective of maintaining an equivalent level of conductivity in all directions of the plane, the perforations are preferably all circular in shape, which advantageously makes it possible to avoid accumulations of electrical charges through spike effects and to limit the effect of the perforations on the metal foil's mechanical resistance while it is being handled, before it is placed on the laminate.

In preferred embodiments of the invention, the perforations are produced with a spacing of between 0.5 and 5 cm.

According to an advantageous feature of the invention, particularly in terms of mass and cost, the metal foil is preferably an aluminum foil that has been perforated during its manufacture by industrial methods, for example and in a non-limiting way by pins placed on a roller feeding the foil and perforating it at the same time.

In other preferred embodiments of the invention a copper-based metal foil is used.

The metal foil according to the invention preferably has a thickness of between 5 and 50 μm, for preference between 5 and 30 μm. Thinness such as this is advantageously allowed thanks to the low degree of perforation per unit area, and also to the reduced size of each of the perforations, which allows the foil perforated in this way to have good solidity, which facilitates its handling for the manufacturing operations of the part according to the invention.

Advantageously, because of this fact, according to the invention, a good compromise is obtained between a reduced mass of the metallization layer, a good solidity of the foils forming part of it and a good effectiveness in dispersing a lightning current at the surface of the part.

In embodiments of the invention, the metal foil can additionally have, on one face or on its two opposite faces, over at least part of its surface, a support layer, comprised of mineral fibers, woven or arranged in felt, e.g. a glass fiber mat formed of an interlacing of glass fibers. On one and/or the other of its faces, this support layer gives it in particular better mechanical solidity and reduces the risks of the foil tearing during handling, especially when it is positioned on the composite laminate (or on the mold). On its outer face, it also improves the cosmetic appearance of the part. The support layer or layers formed of fibers do not extend over the metal foil in its areas of coverage with contiguous foils, which advantageously makes it possible to ensure good continuity of the electrical conductivity from one foil to the next, through the metal foils having direct contact with each other.

The invention also concerns a metal foil for forming a lightning protection metallization layer for manufacturing a part made of a composite formed from thermosetting resin, which meets the features mentioned above.

In a first step of its use for manufacturing the part by molding, this foil is covered by a thin layer of thermosetting resin in a non-polymerized state on one face, and possibly on its two opposite faces.

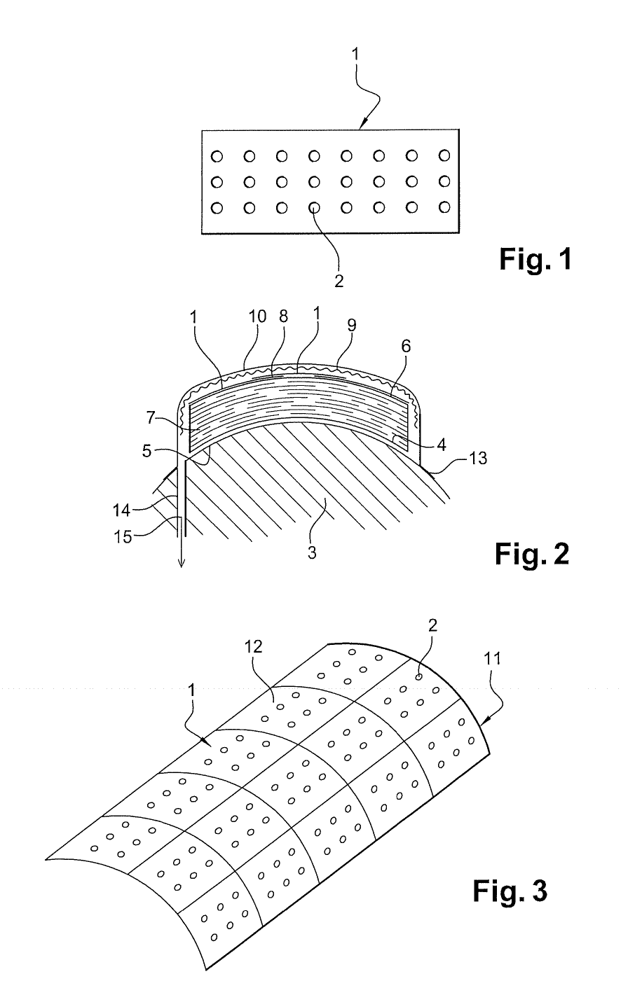

The invention will now be described more precisely in the context of preferred embodiments, that are in no way limiting, shown in FIGS. 1 to 3 in which:

FIG. 1 shows in a top view a metal foil according to the invention;

FIG. 2 shows, schematically, in a cross-section view along a transverse plane, a step of the method of manufacturing a part according to the invention by molding on a male mold;

and FIG. 3 shows in a perspective view an aircraft fuselage panel made of a composite according to the invention.

The invention concerns a part made of a composite formed from a thermosetting resin such as, for instance, an aircraft fuselage panel, including means of protection against the effects of lightning.

These lightning protection means utilize one or more metal foils 1 having perforations 2, as shown in FIG. 1. In this figure, as in the following ones, the perforations are not shown at their actual scale, but with a larger size so that they can be seen better.

In the preferred embodiment of the invention in which several foils are used, the invention advantageously provides for all the foils to be made in a substantially identical way, and also perforated in a similar way, with respect to number, size and pattern of perforations 2, in order to ensure uniformity of both material and electrical conductivity for all the foils 1. The invention does not, however, exclude configurations in which the metal foils differ from each other in one or more features.

The foil 1 is characterized by the metal material it is made of, which ensures its electrical conductivity properties, and also by its thinness, of some tens of microns. It is preferably made of a low-density material, so that the mass of the part in which it is included is not increased significantly.

The metal foil 1 is preferably involute. It is in particular, but not exclusively, an aluminum foil, which offers the advantage of good mechanical solidity at the same time as great lightness and good electrical conductivity per unit of mass, or a copper-based foil. Its thickness is, for example, between 10 and 50 μm, and its mass per unit area between 27 g/m² and 135 g/m² for an aluminum alloy. However, this range of values is in no way restrictive of the invention, and it can be substantially different according to the electrical currents that the part must be able to evacuate, and also according to a minimum mechanical resistance required to allow the foil's utilization during manufacturing of the part.

The foil 1, in the preferred example of realization shown in FIG. 1, has in a plane a substantially rectangular shape. It can be prepared, for example, from a very long foil packaged in a roll.

Each foil 1 can be reinforced over at least part of its surface by a support layer, which is not shown in the figures, comprised of mineral or organic fibers such as fiberglass or an aramid, woven or arranged in felt, e.g. in the form of an interlacing of fibers, arranged substantially parallel to the metal foil 1. Such a feature is advantageous because it leads to the increased mechanical resistance of the foil 1, which allows this foil to be strengthened with respect to risks of it tearing during handling, by operators or automatic devices, e.g. for its positioning during the method of manufacturing the part in which it is intended to be included. The support layer is secured to the metal foil 1, for example thanks to the intrinsic adhesive qualities of a resin deposited on the foil or impregnating the material of the support layer.

Each foil is preferably perforated according to a degree of perforation per unit area, i.e. the ratio of the total surface area of the perforations to the surface area of the foil, that is between 0.005% and 20%, preferably between 0.005% and 5%. Such a degree of perforation advantageously ensures good permeability to the air and solvent vapors, and also the excess resin, without substantially altering the electrical conductivity and a good effectiveness in dispersing the current over the surface of the foil.

The perforations 2 can be produced by any industrial method. They can have any shape, e.g. oblong, elliptical, etc. However, in preferred embodiments of the invention they are advantageously circular, thus ensuring the same level of electrical conductivity in all directions of the plane of the foil, which corresponds to the plane of the figure in the representation of FIG. 1. All the perforations 2 of a single foil 1 preferably, but not exclusively, have a similar shape.

The perforations 2 are preferably positioned according to a regular pattern, e.g. a grid as shown in the figure. In order to obtain both regular and uniform permeability to the air and solvent vapors and the electrical conductivity sought, the spacing of this grid is preferably between 0.5 and 5 cm, for a surface area of each perforation of between 0.1 and 20 mm².

As an example, circular perforations 2 satisfy the values given in table 1 below.

TABLE 1
Perforation characteristics of foil 1

| Spacing | Number of | Diameter | Surface area | Degree of |
|---|---|---|---|---|
| between the | perforations | of a | of a | perforation |
| perforations | per m² of | perforation | perforation | of the |
| (cm) | foil | (mm) | (mm²) | foil (%) |
| 1 | 10,000 | 0.5 | 0.196 | 0.1963 |
| | | 1 | 0.785 | 0.7854 |
| | | 2 | 3.142 | 3.1416 |
| | | 5 | 19.625 | 19.625 |
| 5 | 400 | 0.5 | 0.196 | 0.0079 |
| | | 1 | 0.785 | 0.0314 |
| | | 2 | 3.142 | 0.1257 |
| | | 5 | 19.625 | 0.785 |

The composite used to manufacture the part itself meets standard characteristics known to the person skilled in the art.

It is preferably formed of long continuous fibers, e.g. carbon, glass, aramid, etc. fibers.

The fibers are coated in a hot-polymerizable thermosetting resin, for instance an epoxy resin.

According to a method of manufacturing a part made of a composite according to the invention by molding, a conventional open mold 3 is used.

The invention will be illustrated hereinafter, as an example, in the context of the manufacture of an aircraft fuselage panel, having a curvature, and in the context of the use of a mold 3, known as a male mold, i.e. in which the molding surface 4 is complementary to a concave surface, designated as the lower surface, 5, of the part, opposite to an upper convex surface 6, which is the surface that will be exposed to the aircraft's external environment once the part has been mounted on it.

Such an implementation is not, however, restrictive of the invention, which applies equally, by modifications within the scope of the person skilled in the art, to the case in which a female mold, i.e. having a concave molding surface complementary to the upper convex surface of the part, is used.

Generally, for manufacturing an aircraft fuselage panel, which must satisfy very precise dimensional characteristics in order to allow it to be mounted onto a support frame of the aircraft, by its lower face, the use of a molding method utilizing a mold known as a male mold, which allows the lower concave face of the part to be formed with greater precision, is preferred.

Successive layers of fibers preimpregnated with resin are deposited, in a conventional way, on the molding surface 4 of the mold, so as to form a composite laminate represented schematically in FIG. 2, and globally designated by reference 7.

The composite laminate 7 is covered on its upper face 6 by a continuous metallization layer, formed of one or a plurality of foils 1, preferably with the same composition. The foils 1 thus arranged will be positioned, once the part has been produced, on an upper surface of the part, liable to be exposed to lightning strikes during the aircraft's use.

The foils 1 are positioned with respect to each other so as to ensure the continuity of material and electrical conductivity over the entire surface of the metallization layer. They notably overlay each other at their edges 8, over a length of approximately 15 to 30 mm for example. In the case in which the foils 1 are reinforced by a support layer formed of fibers, on one or both of its faces, this layer does not extend over the area of coverage of the foils, so as to ensure electrical continuity through one foil's direct contact with another.

In this figure, for reasons of clarity, the various elements applied one on top of another in the mold are shown with a slight gap between each of them. It is clearly understood that, in practice, all of these elements are packed together one on top of another.

Preferably, the dimensions of the foils 1 are selected to be smaller than the dimensions of the part to be metallized, which facilitates the metallization of large and/or noninvolute parts, and is compatible with an automated positioning of the foils. The width of the foils is, for example, adapted to the curvatures of the part to be manufactured in the direction of said width.

Before they are positioned on the laminate 7, each foil 1 is preferably covered with a layer of thermosetting resin, preferably of the same type as a resin forming part of the laminate's composition. This is possibly done on its two opposite faces. In particular, such a feature advantageously gives the foil 1 better ability to adhere to the laminate 7 by the face vis-à-vis this latter.

The metallization layer thus formed is then covered by different conventional conjunctive cloths. Among these conjunctive cloths, in particular a bleeder cloth and a breather cloth shown packed together are represented in FIG. 2 by a single element designated as a whole by reference 9. These cloths respectively allow the bleeding of the excess resin in the mold and the evacuation of the air and solvent vapors likely to come from the resin, away from the laminate 7.

The whole is covered by a flexible bladder 10, conventional for such molding methods, fixed hermetically to the mold 3 by its peripheral edge 13. The following steps of the method of manufacturing the part are standard. Low pressure is created inside the mold, under the bladder 10, by sucking air through a pipe 14 opening into the mold, in the direction indicated by reference 15. This has the effect of packing the tapes of preimpregnated fibers against the molding surface 4 under the effect of atmospheric pressure and making them denser. The hot cross-linkage of the resin is then carried out by applying different temperature and pressure cycles, e.g. in an autoclave, under suitable conditions for obtaining a part with the desired properties, chosen according to calculations within the scope of the person skilled in the art.

During these steps, the air and the solvent vapors coming from the resin escape from the laminate 7 via the perforations 2 of the foils 1, which are advantageously realized according to a degree of perforation that is sufficiently high for this, then they are evacuated to the outside via the breather cloth 9 by the suction 15, avoiding the formation of bubbles in the material, a source of porosity that could alter the structural properties of the part produced. The excess resin between the composite laminate 7 and the foils 1 is absorbed by the bleeding cloth 9 by flowing through the perforations 2, which advantageously makes it possible to minimize the thickness of the final compacted part, and also its mass, by improving the level of fibers in the structural portion.

After hardening of the resin and demolding, the part 11 shown in FIG. 3 is obtained. This part has a curvature. Its upper convex surface 12 is designed to be exposed to the outside of the aircraft in the structure of which the part 11 will be mounted, and therefore potentially to lightning strikes. The continuous metallization layer according to the invention, formed of metal foils 1, is located on this upper surface 12. In this figure also, the perforations 2 have been shown larger than they actually are, so that they can be seen better.

The foils 1 can be positioned according to any arrangement on the part, depending in particular on the latter's size and shape. In the embodiment shown in FIG. 3, they are positioned so as to form a regular grid on the part. They can equally well, for instance, be positioned on the part in longitudinal bands, transversal bands, or even at an angle.

In the advantageous embodiment of the invention in which the foils 1 have been covered by resin before being used, at least on their outer surface opposite to the laminate 7, these foils are protected by the resulting resin layer during surface treatment operations that will then be carried out on the part.

During use of the part 11, when it is hit by lightning, the lightning current is effectively and quickly dispersed over the entire upper surface 12 of the part 11, thanks to the good electrical conductivity properties of the metallization layer. The presence of perforations 2 in the degree per unit area and in the surface range chosen according to the invention is advantageously not detrimental for the performance of this dispersion. The current is conducted in all directions from the lightning's point of impact. In this way the risks of damage of the part due to the effects of the lightning strike are avoided.

Because of the thinness of the metal foil used and the choice of a metal with a recognized low density, such as aluminum or an alloy based on aluminum, the part 11 is not made significantly heavier by the presence of the metallization layer, thus it advantageously meets the constraints of optimizing the mass of the constituent parts of aircraft.

The above description clearly illustrates that through its various features and their advantages the present invention realizes the objectives it set itself. In particular, it provides a part made of a composite formed from a thermosetting resin, that has an effective protection against the effects of lightning, at the same time as a reduced mass, and which can be manufactured by a mold with a mainly convex molding surface.

1-12. (canceled)

13. A part made of a composite formed from a thermosetting resin, which includes lightning protection means, wherein said lightning protection means comprise, on an upper surface of said part liable to be exposed to lightning strikes, a continuous layer of a metal foil having perforations, each of which has a surface area less than or equal to 20 mm², and with a degree of perforation between 0.005% and 20%.

14. A part according to claim 13, wherein the degree of perforation is between 0.005% and 5%.

15. A part according to claim 13, wherein the perforations are positioned according to a regular pattern.

16. A part according to claim 15, wherein the regular pattern is a grid.

17. A part according to claim 13, wherein said metal foil is an aluminum foil.

18. A part according to claim 13, wherein the perforations are produced with a spacing of between 0.5 and 5 cm.

19. A part according to claim 13, wherein the perforations are all circular in shape.

20. A part according to claim 13, wherein the metal foil has a thickness of between 5 and 50 μm.

21. A part according to claim 13, wherein the metal foil has, on one face, over at least part of its surface, a support layer.

22. A part according to claim 13, wherein the metal foil has, on two opposite faces, over at least part of its surface, a support layer.

23. A part according to claim 21 wherein the support layer is comprised of mineral fibers, woven or arranged in felt.

24. A part according to claim 22 wherein the support layer is comprised of mineral fibers, woven or arranged in felt.

25. A metal foil for manufacturing a part made of a composite formed from a thermosetting resin according to claim 13.

26. A metal foil according to claim 25, which is covered by a thin layer of said thermosetting resin in a non-polymerized state on one face.

27. A metal foil according to claim 25, which is covered by a thin layer of said thermosetting resin in a non-polymerized state on two opposite faces

28. A method of manufacturing a part made of a composite according to claim 13, whereby:
layers of fibers impregnated with thermosetting resin are deposited over a mold so as to form a composite laminate,
a metal foil or several juxtaposed metal foils, are applied over said laminate so as to form a continuous layer over one face of said laminate,
bleeder and breather cloths and a flexible bladder are successively positioned on said continuous layer,
a partial vacuum is then realized between the bladder and the mold,
and the mold is subjected to temperature and pressure cycles so as to achieve the polymerization of the resin and the compaction of the layers of fibers.

29. A method according to claim 28, whereby the mold has a mainly convex molding surface.

30. A method according to claim 28, whereby the metal foils are covered by a layer of said thermosetting resin on one face.

31. A method according to claim 28, whereby the metal foils are covered by a layer of said thermosetting resin on two faces.
